(19) United States
(12) Patent Application Publication
(10) Pub. No.: US 2023/0400072 A1
(43) Pub. Date: Dec. 14, 2023

(54) BRAKE SHOE HAVING CONTACT FACE WITH VARIABLE WIDTH

(71) Applicant: HL MANDO CORPORATION, Pyeongtaek-si (KR)

(72) Inventors: Hatem SHAHIN, Pfaffenhofen (DE); Lothar WAGNER, Simmern (DE); Kai BRAUN, Friedrichsdorf (DE)

(21) Appl. No.: 18/209,053

(22) Filed: Jun. 13, 2023

(30) Foreign Application Priority Data
Jun. 13, 2022 (DE) 10 2022 205 978.6

(51) Int. Cl. F16D 65/08; F16D 51/20

(52) U.S. Cl. CPC F16D 65/08; F16D 51/20

(57) ABSTRACT

The invention relates to a brake shoe for a drum brake system, the drum brake system comprising a brake drum that is configured to rotate about a rotation axis, the brake shoe having a length configured to extend in a circumferential direction of the brake drum and a width configured to extend in an axial direction of the brake drum, the brake shoe further having a contact face for contacting the brake drum to generate a braking force, wherein a width of the contact face varies along the length of the brake shoe. The invention also relates to a drum brake system comprising two such brake shoes.

### CROSS-REFERENCE TO RELATED APPLICATION

This application is based on and claims priority under 35 U.S.C. § 119 to German Patent Application No. 102022205978.6, filed on Jun. 13, 2022 in the German Patent and Trade Mark Office, the disclosures of which are incorpo-rated herein by reference.

### TECHNICAL FIELD

The invention relates to a brake shoe and a drum brake system comprising such a brake shoe. The brake shoe and the drum brake system may be configured to brake a vehicle, in particular a road vehicle, such as a car, a truck or a bus.

### BACKGROUND

Drum brake systems are an established type of brakes in particular in the field of vehicle brake systems. They comprise a brake drum that is typically coupled to a vehicle wheel and/or to an axle component for a joint rotation therewith about a rotation axis. For generating a braking effect, brake shoes at which a friction lining is arranged are moved into frictional contact with the rotating brake drum. An example of an existing brake drum can be found in DE 10 2018 222125 B3.

One of the technical drawbacks of existing drum brakes is a non-symmetrical and uneven pressure and brake force applied by brake shoes on the drum. For both Simplex and Duplex drum brakes, a force acting on the brake drum, effected by the brake shoes, is often not constant over a length of the brake shoe which results in an undesired temperature distribution and an uneven distribution of friction. This in turn reduces braking efficiency and causes dust, corrosion and noise. Moreover, the pressure and brake force differs between the leading brake shoe and the trailing brake shoe which is often not appro-priately accounted for.

### SUMMARY

It is therefore an object of the present invention to limit at least some of these existing drawbacks.

This is achieved by a brake shoe brake system according to the attached independent claims. Advantageous embodiments are set out in the depend-ent claims and in this description.

Accordingly, a brake shoe for a drum brake system is disclosed, the drum brake system comprising a brake drum that is configured to rotate about a rotation axis, the brake shoe having a length configured to extend in a circumferential direction of the brake drum and a width configured to extend in an axial direction of the brake drum. The brake shoe also has a contact face for contacting the brake drum to generate braking forces, wherein a width of the contact face varies along the length of the brake shoe.

Such as axial, radial and circumferential when used herein may generally relate to the rotation axis. An axial direction may extend along the rotation axis, a radial direction may extend orthogonally thereto and a circumferential direction may extend around or about the rotational axis.

It has been determined that by varying the width, the area of the contact face can be varied along the length of the brake shoe as well. This can equalise the pressure along the contact face in view of the non-uniform force distribution along the said length. Specifically, it has been determined that the pressure acting on the contact face is a function of the locally varying contact forces and the (e.g. local or effective) size of the contact face. Thus, when varying a size of said contact face and specifically its axial width, the varying contact forces can at least partially be compensated for to render the pressure more uniform along the length. By way of this, a more even pressure distribution and/or a more even friction distribution during braking can be achieved.

The brake shoe may have a holder (lining holder), e.g. made of metal. The holder may have a lining support portion at which a friction lining is arranged. The friction lining may comprise the contact face. The contact face may comprise the entire surface of the friction lining, said surface facing an opposite surface of the brake drum, in particular an inner circumferential surface of the brake drum. Alternatively, the contact face may comprise only part and in particular a majority of said surface of the friction facing the brake drum.

In a generally known manner, the brake drum may be coupled to an axle component and/or to a vehicle wheel for a joint rotation therewith about the rotation axis. The brake drum may rotate relative to the brake shoe. The brake shoe may be tiltable in a plane extending at an angle and in particular orthogonally to the rotation axis. By way of said tilting movement, the brake shoe may be forced into contact with the brake drum and lifted off therefrom.

The brake shoe may be secured to a back plate that is at least partially received in a receiving space of the brake drum.

According to an embodiment, the width of the contact face varies in accordance with a distribution over a contact force (e.g. the length dimension) at the contact face during braking. Specifically, the variation of said width may be similar to or, differently put, may correlate with the variation of said contact force. This may in particular apply when viewed along the length of the brake shoe. For example, the variation (in particular expressed as a relative decrease or increase e.g. with reference to a nominal or average value) of the width and of the contact forces being similar, proportional or identical at same positions or within same regions along said lengths.

By varying width of the contact face as a function of the (e.g. locally present) contact forces, the braking pressure acting between the contact face and brake drum and affecting heat distribution and brake force generation can be rendered more uniform.

In one example, there is a antiproportional relation between the width and the value of contact forces and/or a direct correlation between the decreasing width and increasing contact force (and/or increasing width and decreasing contact force, respectively). Specifically, when the contact force increases in a certain section of the contact face (e.g. by a certain percentage relative to a nominal or average value), the width may decrease in said section (e.g. by a certain percentage relative to a nominal average value), in particular by a proportional amount compared to the increase of the contact force. On the other hand, the contact force decreases in a certain section of the contact face, the width may increase in said section, in particular proportionally to said decrease of the contact force.

Note that the contact force may also be referred to as a brake force. It may be equivalent to a force applied by the brake shoe on the drum. It may extend orthogonally with respect to the contact face and/or with respect to an inner circumferential face of the brake drum that is contacted by the brake shoe.

According to a further example, the width of the contact face varies so that a pressure at the contact face during braking is substantially (or fully) constant along the length of the contact face. This may be achieved by varying the width of the contact face, so that, preferably at each position along the length of the brake shoe, a ratio of the contact force divided by the area is the substantially equal (e.g. does not deviate by more than 10% or more than 5%).

In one aspect, the width of the contact face decreases from one circumferential end portion of the contact face to another circumferential end portion of the contact face. Depending on whether a clockwise or anti-clockwise orientation of a circumferential direction is considered, said decrease may also correspond to an increase (e.g. when viewed in the respective oppositely oriented circumferential direction).

The circumferential end portions may define different and in particular opposite ends of the contact face along the length of the brake shoe. Put differently, said ends may be separated in the circumferential direction by a length of the contact face and/or brake shoe. In this connection, there may be a gradual, stepped, continuous or constant variation and in particular a decrease of the width. It has been found that this represent a particularly effective way of varying the width in accordance with a variation of the contact force along the length of the brake shoe.

On the other hand, it may be provided, but is less preferred, that there is only a locally concentrated variation, e.g. in a centre portion of the contact face along its length, while the opposite circumferential and portions are substantially similar in width. This has been found to be less effective for rendering the brake pressure uniform along the length, but still bring about some improvement compared to a constant width.

The circumferential end portions may comprise or from edges of the brake shoe, such as a trailing edge and a leading edge. The latter also referred to as a trading side or a leading site herein. For example, the brake drum may have a main rotating direction, corresponding for instance to a forward movement of a vehicle in which the brake drum system is provided. The brake shoe may engage with a surface of the brake drum and specifically a given portion of the brake drum may first enter into contact with the brake shoe at the brake shoe's leading edge or leading side, and then move along the brake shoe to the brake shoe's trailing side. It may typically be determined from the brake shoe itself, which side is the trailing side and which side is the leading side, e.g. by its shape and/or is connection portions to the backing plate, to a brake actuator, to a resetting spring and the like.

One of the circumferential end portions may define a largest width of the contact face. The other one of the circumferential end portions may define a smallest width of the contact face. This may reflect a corresponding variation of the contact force between the respective positions along the length of the contact face. Specifically, it has been observed that the contact force along the contact face varies from a comparatively low (e.g. at the leading side) to a comparatively large value (e.g. at the trailing side), so that providing maximal and minimal widths at said end portions is an effective way to equalise pressure along the length of the brake shoe. Accordingly, the brake shoe may generally have increasing width from the leading side to the trading side.

In another embodiment, the width of the contact face varies steplessly along the length, e.g. by decreasing or increasing continuously between the circumferential end portions. For example, there may be a continuous decrease without any intermediate increase (or vice versa) and/or without any section having a constant width. This provides a suitable adjustment to observed variations of the contact force along the length.

According to another example, the width varies linearly along the length. For example, an extent of the decrease (or increase) of the width per unit length may be constant along the length of the contact face.

The brake shoe may be configured as a leading brake shoe of the drum brake system. Alternatively, the brake shoe may be configured as a trailing brake shoe of the drum brake system. In particular, a drum brake system is disclosed herein which has a leading brake shoe and a trailing brake shoe, wherein both the leading brake shoe and the trailing brake shoe are configured according to any of the embodiments shown and described herein. The definition of brake shoes in drum brakes as being a leading brake shoe or a trailing brake shoe is known to the skilled person. It is based on a direction of movement (in particular tilting movement) of the brake shoe during braking with respect to a (in particular main) direction of rotation of the brake drum. For example, when moving against said direction of rotation, the brake shoe may be referred to as a trailing brake shoe. When moving in said direction of rotation, the brake shoe may be referred to as a leading brake shoe.

In order to provide the varying width along its length, the brake shoe and in particular its contact face may comprise at least two segments, in particular at least three segments, with different widths. This may e.g. include any of different average widths, different maximum widths and different minimum widths. The segments may be physical segments, e.g. defined or separated by distinct structural features, such as gaps or recesses. Alternatively, the segments may be virtual segments and may e.g. represent a virtual segmentation of the contact face into continuous and/or homogenous regions.

The segments may also be referred to as length segments. They may each include a defined portion of the length of the brake shoe and/or contact face, said portions being different (i.e., non-overlapping) from one another. In one example, the axial width varies within at least one of the segments. In another example, the width is constant in at least one segment. The segments may be provided only in a friction lining or also in a lining holder.

In an example, the at least two segments or the at least three segments (which may be provided in the brake lining, in the lining holder, or in both the brake lining and the lining holder) comprise a first segment being a leading segment or a trailing segment, and a second segment adjacent to the first segment. Therein the width in the first segment may be at least 5% or at least % less than the width in the second segment. For example, the width may be up to 20% less than that of the second segment. The second segment may constitute a respective other of the trailing segment and leading segment, or there may be one or more further segments arranged after the second segment, further towards the trailing end of the brake shoe.

First

In an example, a third segment is provided adjacent to the second segment, i.e., opposite to the first segment, wherein the axial width of the third segment is a least 5% or a least 10% more than width in the second segment.

In an example, width in the third segment may be up to 20% more than that of the second segment. The third segment may compared to the first segment constitute a respective other of the leading segment or trailing segment, or there may be one or more further segments arranged after the third segment, e.g. further towards the trailing or leading end of the brake shoe.

In another aspect, the contact face is formed by a friction lining that is arranged at a lining support portion of a lining holder of the brake shoe and a width of the lining support portion varies, in particular in accordance with the width variation of the contact face. For example, the contact face and the lining support portion may be congruent along the length. This increases compactness and reduces weight while ensuring a reliable support of the friction lining.

The lining holder may comprise a material that is different from a (e.g. friction) material of the friction lining. For example, the lining holder may be a metallic member, in particular a one-piece member.

The invention also relates to a drum brake system, comprising:
a brake drum that is configured to rotate about a rotation axis,
a first brake shoe and a second brake shoe, each brake shoe being configured according to any of the previous claims,
in particular wherein, when viewed in along a circumferential direction, the widths of the contact face of one of the first brake shoe and of the contact face of the second brake shoe vary differently.

It has been determined that the distribution of contact forces for each of the brake shoes may be different and in particular may vary differently in a circumferential direction. Therefore, it is suggested to vary the width of the contact forces independently from one another for each brake shoe to provide suitable individual adjustments of said width.

This may be equivalent to the contact faces being mirror asymmetric to one another, e.g. with respect to a symmetry plane comprising a radial axis and the rotation axis. Said symmetry plane may e.g. extend in a space in between and/or may not intersect any of the brake shoes.

In still other words, when viewed along a (e.g. height) axis that radially extends in between and/or not intersect any of the brake shoes, the width of the contact faces of the brake shoes may be different and in particular may vary differently in same positions of and/or same regions along said axis.

Additionally or alternatively, when viewed along a circumferential direction that corresponds to a main direction of rotation of the brake drum (e.g. the rotating direction when the vehicle moves forward), the width of one of the contact faces may decrease, whereas the width of the other contact face may increase. For example, one of the brake shoes may have a trailing edge (or trailing side) forming a comparatively wide end portion of the contact face, whereas the other brake shoe may have a circumferentially adjacent leading edge (or leading side) forming a comparatively narrow end portion of the contact face. Alternatively, a comparatively narrow trailing edge may be adjacent to a comparatively wide leading edge of the other brake shoe.

It has been found that this represents a particularly effective way of adjusting the widths of the contact faces to the contact forces respectively applied thereto in order to achieve a substantially uniform brake pressure distribution.

In this context, it may be provided that the contact face having the increasing width is comprised by the first brake shoe which is a leading brake shoe (e.g with respect to a main direction of rotation disclosed herein). In particular, said leading brake shoe may have a narrower leading edge compared to a wider trailing edge.

In general, different variations of the axial width between the brake shoes may include at least one of:
the first brake shoe and second brake shoe having different extents of variation per same unit length or, differently put, the rate of variation of the width along the length may be different between the brake shoes;
the leading brake shoe and the trailing brake shoe have different differences between the axial widths of their respective circumferential end portions (or, differently put, between their respective leading and trailing edge).

Additionally or alternatively, both brakes shoes may have a leading side and a trailing side (e.g. with reference to the main direction of rotation) and may both the have an increasing width from said leading side to said trailing side.

Any of the above measures represent effective ways of adjusting the contact faces to the respective distribution of contact forces applied thereto.

Additionally or alternatively, the absolute values of an average width, a maximum width or a minimum width may be different between the brake shoes. For example, the leading brake shoe may have a larger average width, a larger maximum width and/or a larger minimum width than the trailing brake shoe. This takes account of the typically larger contact forces applied to the leading brake shoe.

### BRIEF DESCRIPTION OF DRAWINGS

Embodiments of the invention are discussed below with respect to the attached schematic figures. In the figures, same or similar features may be marked with same reference signs.

FIG. 1 shows a drum brake system according to an embodiment of the invention and a pressure distribution along a length of the brake shoes.

FIG. 2 shows a non-uniform pressure distribution according to the state of the art.

FIG. 3 shows a uniform pressure distribution as provided by the embodiment of FIG. 1.

FIG. 4 is a front view of a contact face of a trailing brake shoe of the drum brake system of FIG. 1.

FIG. 5 is a front view of a contact face of a leading brake shoe of the drum brake system of FIG. 1.

FIG. 6 shows a drum brake system according to another embodiment of the invention.

### DETAILED DESCRIPTION

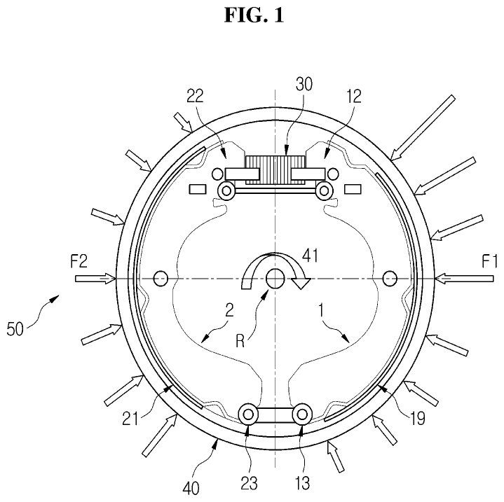

FIG. 1 schematically shows a drum brake system 50 for a vehicle. The drum brake system 50 has a brake drum 40 with a main rotating direction 41 (indicated by an arrow) about a rotation axis R, the main rotating direction 41 corresponding to the vehicle moving in a forward direction.

The drum brake system 50 has a back plate assembly with two brake shoes 1, 2. The brake shoes 1, 2 each have a brake lining 19, 21, made of a friction material, and a lining holder 12, 22, made for instance of cast metal or steel. The brake shoes 1, 2 each have a pivot axis 13, 23 at the bottom, where they are pivotably connected to a back plate, and there is an actuator 30 provided near the top of the brake shoes 1, 2, configured for pressing the brake shoes 1, 2 outward and against the brake drum 40 for braking. Accordingly, and in view of the main rotating direction 41 of the brake drum 40, the brake shoe 1 on the right is a leading brake shoe, and the brake shoe 2 on the left is a trailing brake shoe.

In FIG. 1, a brake force distribution F1 for the leading brake shoe 1, and a contact force distribution F2 for the trailing brake shoe 2 is indicated by way of arrows, longer arrows indicating higher contact force (or, in other words, brake force), and shorter arrows indicating lower contact force. For both brake shoes 1, 2 the contact force decreases from the leading side to the trailing side. Moreover, the contact force of the trailing brake shoe 2 is less than contact force at the leading brake shoe 1. These distributions are due to the mechanical setup of the drum brake and may for instance result in less than optimal stopping power and uneven heating and wear.

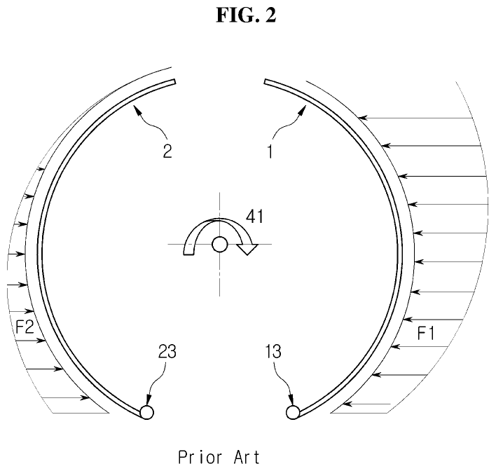

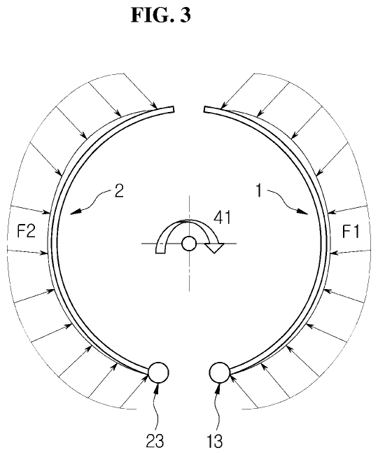

Turning to FIGS. 2 and 3, a typical uneven force distribution according to the prior art is shown in FIG. 2, and an even pressure distribution is shown in FIG. 3. It is an object of the invention that is solved by the depicted embodiments, to enable a more evenly distributed brake force, i.e., go from the prior art force distribution of FIG. 2 towards the force distribution of FIG. 3.

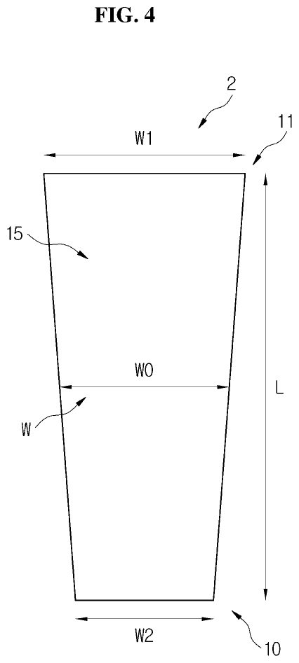

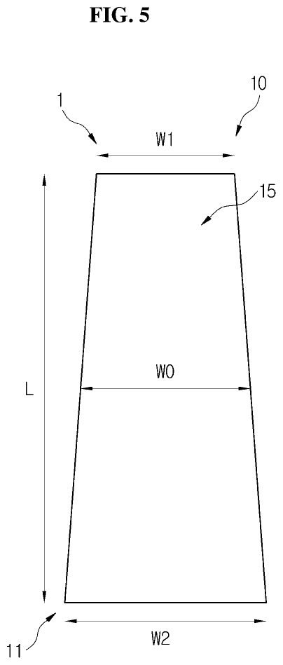

The brake linings 19, 21 each comprise a contact face 15 for contacting an inner circumferential face of the brake drum 40. The contact faces 15 of the brake linings 19, 21 FIG. 1 are depicted in FIGS. 4 and 5 in detail. FIGS. 4 and 5 are front views of the brake shoes 1, 2, respectively. The viewing angle corresponds to turning the respective brake shoes 1, 2 of FIG. 1 by an amount of 90° so that their respective contact faces 15 face the viewer. The contact face 15 and length L are thus actually curved relative to the image plane. Yet, FIGS. 4 and 5 would be similar if considering developed lengths L or developed configurations of the contact faces 15 or projections thereof into the image plane. The contact faces 15 are in each case continuous faces.

Accordingly FIGS. 4 and 5 in conjunction with FIG. 1 illustrate that each of the brake shoes 1, 2 and specifically their respective contact faces 15 have a length L configured to extend in a circumferential direction of the brake drum of the drum brake system 50. Also, each of the brake shoes 1, 2 has a width configured to extend in an axial direction of the brake drum 40.

As further evident from FIG. 1 and FIGS. 4-5 when viewed in conjunction, the brake shoes 1, 2 have a varying width W along their length L. More precisely, they have a width W that changes from their leading side 10 to their trailing side 11, wherein the leading side 10 and trailing side 11 each form circumferential end portions of a respective brake shoe 1, 2.

A basic idea of the depicted embodiment is to match the width W at the different positions along the length L of each brake shoe 1, 2 to meet a target of relatively constant pressure along with the total circumference of the brake drum 40. The width W is thus varied in accordance with (or, put differently, is adjusted to) the varying contact forces explained with reference to FIGS. 1-3 above. Specifically, the width W is varied so as to achieve a substantially constant ratio between a local area of the contact face 15 as defined by the width and a certain length unit (e.g. comprising between 1% and 10% of the total length L). Therefore, said ratio generally increases in regions of high contact forces and decreases in regions of low contact forces. This is evident when comparing FIGS. 1-3 to FIGS. 4-5.

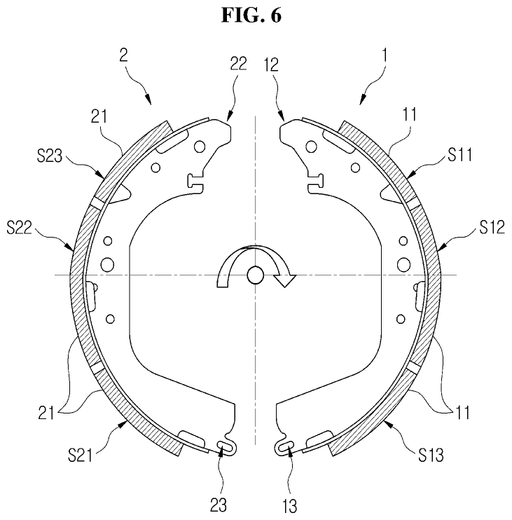

In more detail, for the leading brake shoe 1 on the right in FIG. 1, the leading side 10 is at the top, and the width W increase from top (W1) to bottom (W2) (see FIG. 6), i.e. from the leading side 10 to the trailing side 11. For the trailing brake shoe 2 on the left in FIG. 1, the leading side 10 is at the bottom, and the width W increases from bottom (W2) to top (W1) (see FIG. 5), i.e. again increases from the leading side 10 to the trailing side 11. An average or nominal width W0, that may also be referred to as a reference width, is also shown in FIGS. 5-6. As a mere example, it is located at about half the length L of each of the brake shoes 1, 2.

In FIGS. 4-5, the width W changes steplessly and linearly for both brake shoes 1, 2. As a mere example that has been found to achieve a satisfying pressure equalisation the following may be provided: In case of the trailing brake shoe 2, the width W1 at the trailing side 11 is between 3% and up to 10% larger than the average width W0, whereas the width W2 at the leading side 10 is between 3% and up to 10% smaller than the average width W0. In case of the leading brake shoe 1, the width W1 at the leading side 10 is between 2% and up to 7% smaller than the average width W0, whereas the width W2 at the trailing side 11 is between 2% and up to 7% larger than the average width W0. The average width W0 may be larger (e.g. between 10% and 50% larger) for the leading brake shoe 1 compared to the trailing brake shoe 2. In one example, the average width WO of the leading brake shoe 1 is 40 mm.

Referring to FIG. 6 an optional segmentation is shown according to which each of the leading brake shoe 1 and the trailing brake shoe 2 comprises three segments S11, S12, S13; S21, S22, S23, with different widths and/or different width variations. The segments S11, S12, S13; S21, S22, S23 are provided in the linings 19, 21. The general variation of the width W is similar to that of FIGS. 5 and 6, e.g. continuously increases from a respective leading side 10 to a trailing edge 11. The segments S11, S12, S13; S21, S22, S23 may be separated by grooves or notches extending in a width direction. Alternatively, they may be integrally formed and connected.

The leading brake shoe 1 has a first segment S11 which constitutes a leading segment, a second segment S12 which constitutes a central segment, and a third segment S13 which constitutes a trailing segment. In the second segment S12, the central segment, the brake lining 19 has a nominal width W0 of e.g. 40 mm. The width W0 varies in said segment S12 by 15% (i. e. increasing in a direction towards the trailing side 11).

In the first segment S11 of the leading brake shoe 1, a nominal value of the Width WO is reduced (e.g. at maximum) by 10% to 20% as compared to that of the central second segment S12. In the third segment S13, the trailing segment of the leading brake shoe 1, a nominal value is increased (e.g. at maximum) by 10% to 20% as compared to that of the central second segment S12. Again, the width may vary within each of the segments, and e.g. continuously, by 15% or more (i.e. a maximum and minimum width W with each segment S12, S13 differing by 15% or more).

In the case of the trailing brake shoe 2, there is also a first segment S21 which constitutes a leading segment, a second segment S22 which constitutes a central segment, and a third segment S23 which constitutes a trailing segment. In the second segment S22, the central segment, the brake lining 19 has a nominal width W0 of e.g. 40 mm. The width W0 varies in said segment S12 by 15% (i. e. increasing in a direction towards the trailing side 11).

In the first segment S21 of the trailing brake shoe 2, a nominal value of the Width WO is reduced (e.g. at maximum) by 10% to 20% as compared to that of the central second segment S12. In the third segment S23, the trailing segment of the leading brake shoe 1, a nominal value is increased (e.g. at maximum) by 10% to 20% as compared to that of the central second segment S12. Again, the width W may vary within each of the segments S11, S12, S13; S21, S22, S23, and e.g. continuously, by 15% or more (i.e. a maximum and minimum width W within each segment S12, S13 differing by 15% or more).

The number of segments S11, S12, S13; S21, S22, S23, is not limited to three, but there may e.g. be only two or four or five segments S11, S12, S13; S21, S22, S23 (or more).

What is claimed is:

1. A brake shoe for a drum brake system, the drum brake system comprising a brake drum that is configured to rotate about a rotation axis,
the brake shoe having a length configured to extend in a circumferential direction of the brake drum and a width configured to extend in an axial direction of the brake drum,
the brake shoe further having a contact face for contacting the brake drum to generate a braking force,
wherein a width of the contact face varies along the length of the brake shoe.

2. The brake shoe according to claim 1,
wherein the width of the contact face varies in accordance with a distribution of a contact force at the contact face during braking.

3. The brake shoe according to claim 2,
wherein the width of the contact face varies so that a pressure occurring at the contact face during braking is substantially constant along the length of the contact face.

4. The brake shoe according to claim 1,
wherein the width of the contact face decreases from one circumferential end portion of the contact face to another circumferential end portion of the contact face.

5. The brake shoe according to claim 4,
wherein one of said circumferential end portions defines a largest width of the contact face, and in particular wherein the respective other circumferential end portion may defines a smallest width of the contact face.

6. The brake shoe according to claim 1,
wherein the width of the contact face varies steplessly along the length.

7. The brake shoe according to claim 6,
wherein the width of the contact face varies linearly along the length.

8. A drum brake system,
comprising:
a brake drum that is configured to rotate about a rotation axis,
a first brake shoe and a second brake shoe, each configured according to claim 1.

9. The drum brake system of claim 8,
wherein, when viewed in along a circumferential direction, the width of the contact face of the first brake shoe and the width of the contact face of the second brake shoe vary differently.

10. The drum brake system according to claim 9,
wherein the different variation of the width includes that, when viewed along a circumferential direction that corresponds to a main direction of rotation of the brake drum, the width of the contact face of one of the brake shoes decreases, whereas the width of the contact face of the other brake shoes increases.

11. The drum brake system according to claim 10,
wherein the contact face having the increasing width is comprised by the first brake shoe which is a leading brake shoe.

12. The drum brake system according to claim 9,
wherein the different variation of the width includes at least one of:
the first brake shoe and second brake shoe having different extents of variation per same unit length;
the leading brake shoe and trailing brake shoe having different differences between the widths of their respective circumferential end portions.

13. The drum brake system according to claim 8,
wherein both brakes shoes have a leading side and a trailing side and have an increasing width from said leading side to said trailing side.

14. The drum brake system according to claim 8,
wherein the absolute values of an average width, a maximum width or a minimum width are different between the brake shoes.
